(19) United States
(12) Patent Application Publication
(10) Pub. No.: US 2020/0259862 A1
(43) Pub. Date: Aug. 13, 2020

(54) SYSTEM AND METHOD FOR NEAR REAL TIME DETECTION OF ATTACKS AND INFLUENCE IN SOCIAL NETWORKS

(71) Applicant: CYABRA STRATEGY LTD., Tel-Aviv (IL)

(72) Inventors: YOSSEF DAAR, ALEI ZAHAV (IL); DAN BRAHMY, RAANANA (IL); IDO SHRAGA, NETANYA (IL); SENDI FRANGI, GIVAT SHMUEL (IL)

(21) Appl. No.: 16/779,735

(22) Filed: Feb. 3, 2020

Related U.S. Application Data
(60) Provisional application No. 62/803,605, filed on Feb. 11, 2019.

(51) Int. Cl. H04L 29/06; G06Q 50/00; G06N 3/08

(52) U.S. Cl. CPC H04L 63/1483; G06Q 50/01; H04L 63/1466; G06N 3/08; H04L 63/1416

(57) ABSTRACT

A system for identifying attacks against a customer in a social network includes a conversation monitor, a user type detector and an attack identifier. The conversation monitor discovers a plurality of users participating in a discourse related to the customer. The user type detector identifies the type of each user that can be real or fake and the attack identifier identifies an attack according to the type of the users. A method for identifying a fake user in a social network includes evaluating an authenticity of a user by applying a set of tests, each test in the set includes one or more rules on one or more parameters associated with the user, each test creating a weighted score. The method also includes calculating a weighted average score from the weighted scores and determining if a user is fake according to the weighted average score compared to a configured threshold.

### CROSS-REFERENCE TO RELATED APPLICATIONS

This application claims priority and benefit from U.S. Provisional Patent Application No. 62/803,605, filed Feb. 11, 2019, the contents of which are incorporated herein by reference.

### FIELD

The invention relates to online social networks generally and to detecting attacks and campaigns in social media in particular.

### BACKGROUND

Social media (online social networks) are online platforms which people use to build social networks in which they can publicly express themselves and share information with people across the world. The social media have evolved and grown rapidly and is now widely and frequently used all over the world. Social media may be used for achieving both personal and commercial objectives such as advertising, branding, creating a positive discourse and the like.

The structure, capabilities and frequency of use of the social media, enables content, created and shared by users of an online social network, to be quickly and widely spread to users of the online social network and to other online social networks and therefore may rapidly become accessible to a large audience that may propagated it further.

As a result of the friendly nature of the social media, users tend to trust the content to which they are exposed and may not be aware of the source nor of the intention behind the received content. Subsequently, social media can be exploited and used maliciously to control and manipulate the discourse. Social media, in addition to the benefits it provides, is often seen as a big threat to individuals and businesses since it may be used to distribute fake news and false information that may affect them and their business.

Malicious use of the social media may be applied, for example, by creating negative campaign attacks. A campaign in the social media is an organized and orchestrated discourse which may be either negative or positive. In a positive campaign some users, participating in the discourse, may use positive sentiment towards a specific target which may be a subject or an issue or a person etc. In a negative campaign, some participants may use negative sentiment towards the target.

A campaign or an attack may be characterized by the participation of fake and real accounts. Fake accounts, also called fake users may manipulate, control and amplify the discourse. Fake accounts may be used by bots and avatars to spread negative content by inflating clicks, likes and shares and to automatically create and spread harmful content to a large audience. Malicious use of the social media may also be applied by creating a positive campaign using the same tools used for negative campaigns.

### SUMMARY

There is provided in accordance with an embodiment of the invention a system for identifying attacks against a customer in a social network. The system includes a conversation monitor, a user type detector and an attack identifier. The conversation monitor discovers a plurality of users participating in a discourse related to the customer. The user type detector identifies a type of a user from the plurality of users as either real or fake and the attack identifier identifies an attack according to the type of the users.

Additionally, in accordance with an embodiment of the invention, an attack is a negative campaign that include one or more fake users and is orchestrated by one or more real users.

Moreover, in accordance with an embodiment of the invention, the system also includes a discourse analyzer to identify one or more key elements in the discourse and discover the plurality of users participating in conversations containing one of the key elements.

Furthermore, in accordance with an embodiment of the invention, the user type detector also includes an activity analyzer to analyze an activity of each user and provide indications regarding the type of the user according to the activity.

Additionally, in accordance with an embodiment of the invention, the user type detector also comprises a language analyzer to analyze a language of each user and provide indications regarding the type of the user according to the language.

Furthermore, in accordance with an embodiment of the invention, the user type detector also includes a link analyzer to analyze a structure of a social network of each user and provide indications regarding the type of the user according to the structure of the social network.

Still further, in accordance with an embodiment of the invention, the user type detector also includes a visual content analyzer to analyze a category of visual content, related to each user, the category of content is genuine, modified or generated and provide indications regarding the type of the user according to the detected type.

Still further, in accordance with an embodiment of the invention, the user type detector also includes a fake user detector to define whether a fake user is a bot or an avatar in a network of fake users.

Additionally, in accordance with an embodiment of the invention, the user type detector also includes a unified entity creator to create for each user a unified entity representing the user in a plurality of networks.

Moreover, in accordance with an embodiment of the invention, the attack identifier identifies an attack according to the number of users having a type fake.

There is provided in accordance with an embodiment of the invention a method for identifying attacks against a customer in a social network. The method includes discovering users participating in a discourse related to the customer, identifying a type of each user and identifying an attack according to the type of the users.

Additionally, in accordance with an embodiment of the invention, an attack is a negative campaign that includes one or more fake users and is orchestrated by one or more real users.

Moreover, in accordance with an embodiment of the invention, the method also includes identifying one or more key elements in the discourse and discovering the plurality of users participating in conversations containing one of the key elements.

Furthermore, in accordance with an embodiment of the invention, the identifying includes analyzing an activity of each user and providing indications regarding the type of the user according to the activity.

Additionally, in accordance with an embodiment of the invention, the identifying also includes analyzing a language of each user and providing indications regarding the type of the user according to the language.

Moreover, in accordance with an embodiment of the invention, the identifying also includes analyzing a structure of a network of each user and providing indications regarding the type of the user according to the structure of the network.

Furthermore, in accordance with an embodiment of the invention, the identifying also includes detecting a category of visual content related to each user, the category is genuine, modified or generated and providing an indication regarding the type of the user according to the detected type.

Still further, in accordance with an embodiment of the invention, the identifying also includes defining whether a fake user is either a bot or an avatar.

Still further, in accordance with an embodiment of the invention, the identifying also includes creating for each user a unified entity representing the user in a plurality of networks.

Moreover, in accordance with an embodiment of the invention, the identifying also includes considering the unified entity.

There is provided in accordance with an embodiment of the invention a method for identifying a fake user in a social network. The method includes evaluating an authenticity of a user by applying a set of tests, each test in the set includes one or more rules on one or more parameters associated with the user, each test creating a weighted score. The method also includes calculating a weighted average score from the weighted scores and determining if a user is fake according to the weighted average score compared to a configured threshold.

Additionally, in accordance with an embodiment of the invention, a test is an artificial neural network (ANN), the rules are the structure of the ANN and the weighted score is the output of the ANN.

Moreover, in accordance with an embodiment of the invention, the set of tests includes analyzing the language of the user and extracting a set of characteristics, building an expected profile from the characteristics, comparing the expected profile with an actual profile provided by the user and creating a language score reflecting the degree of variation between the expected profile and the actual profile.

Additionally, the set of tests includes detecting a category of visual content related to each user, the category is genuine, modified or generated, and providing an indication regarding the type of the user according to the detected type.

Furthermore, in accordance with an embodiment of the invention, the detecting a category of visual content comprises using a generative adversarial network (GAN) to detect generated visual content.

### BRIEF DESCRIPTION OF THE DRAWINGS

The subject matter regarded as the invention is particularly pointed out and distinctly claimed in the concluding portion of the specification. The invention, however, both as to organization and method of operation, together with aspects thereof, may be understood by reference to the following detailed description when read with the accompanying drawings in which:

FIG. 1 is schematic illustration of an attack detector system, according to embodiments of the invention;

FIG. 2 is a schematic illustration of a flow implemented by the attack detector system of FIG. 1, according to embodiments of the invention;

FIG. 3 is a schematic illustration of a conversation monitor used by the attack detector system of FIG. 1, according to embodiments of the invention;

FIG. 4 is a schematic illustration of a database storing information used by the attack detector system of FIG. 1;

FIG. 5 is a schematic illustration of a discourse analyzer used by the attack detector system of FIG. 1, according to embodiments of the invention;

FIG. 6A is a schematic illustration of a user type detector, used by the attack detector system of FIG. 1, according to embodiments of the invention;

FIG. 6B is a schematic illustration of a flow implemented by user type detector of FIG. 6A, according to an embodiment of the invention; and

FIG. 7 is a schematic illustration of an attack identifier, used by the attack detector system of FIG. 1, according to embodiments of the invention.

It will be appreciated that for simplicity and clarity of illustration, elements shown in the figures have not necessarily been drawn to scale. For example, the dimensions of some of the elements may be exaggerated relative to other elements, for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the invention may be practiced without these specific details. In other instances, well-known methods, procedures, features and components have not been described in detail so as not to obscure the invention. In the accompanied drawings, similar numbers refer to similar elements in different drawings.

Methods and systems according to embodiments of the invention are directed at ongoing monitoring of social networks, providing a fast identification of fictitious negative campaign attacks and providing a thorough analysis of the attack. An attack may be characterized by excessive participation of fake users in the various online social networks and extensive distribution of harmful information and/or fake information, including generated and manipulated content (both visual and lingual). Once an attack has been detected, the nature of the attack may be analyzed, and detailed information related to the attack may be displayed including a visible distinction between real and fake conversations.

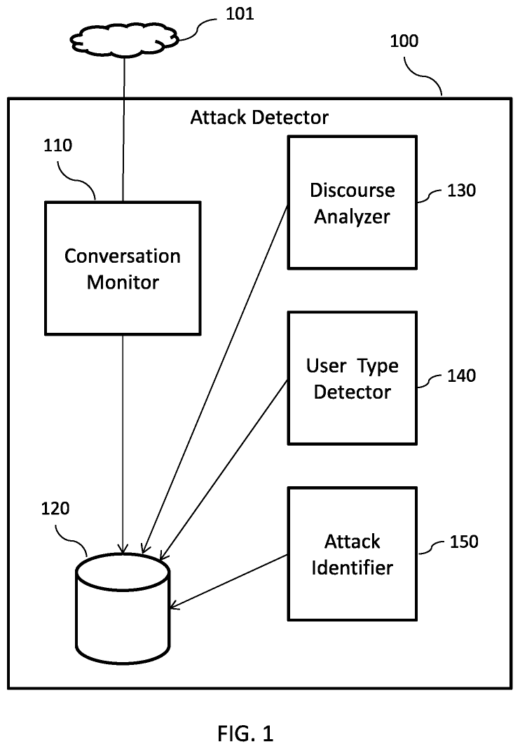

FIG. 1, to which reference is now made, is a schematic illustration of an attack detector system 100 constructed and operative in accordance with an embodiment of the invention. Attack detector system 100 may be connected to the internet 101 and comprises a conversation monitor 110 to monitor the discussions related to the customer in different social networks; a database 120 to store the information collected by conversation monitor 110; a discourse analyzer 130 to extract frequent subjects, keywords or any other means of expressions such as emojis, caricatures and the like, used in conversations of the discourse stored in database 120; a user type detector 140 to identify fake and real users amongst the users participating in different conversations; and an attack identifier 150 to analyze the collected information, identify attacks and negative campaigns in the discourse and display information related to the discourse. The information may include keywords and subjects common to the discourse and indications regarding fake users participating in it. In addition, attack identifier 150 may create alerts regarding attacks detected in the discourse. Attack detector system 100 may be implementable on a computing device using any non-transitory computer readable medium of a hardware processor equipped with any type of processor using any type of memory.

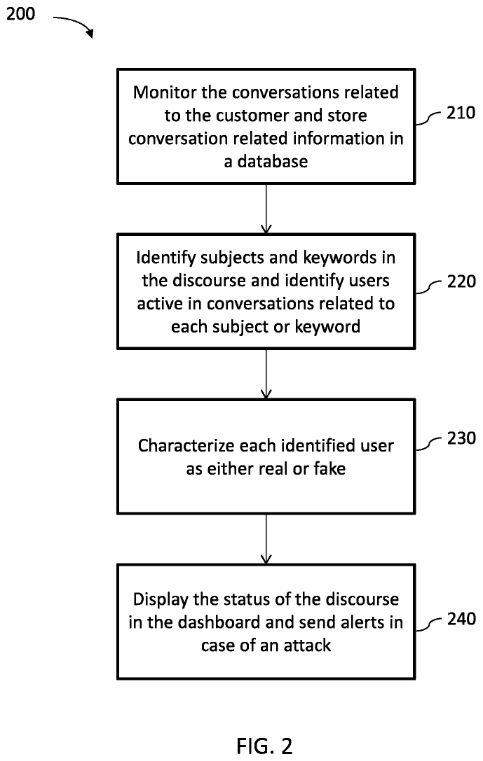

FIG. 2, to which reference is now made, is a schematic illustration of a flow 200 implemented by attack detector system 100 according to an embodiment of the invention. In step 210 conversation monitor 110 may monitor the different online social networks, identify conversations related to the customer of the system and store the information related to the identified conversation in database 120. In step 220, discourse analyzer 130 may identify subjects and keywords in the discourse, stored in database 120, and may identify the different users who are active in conversations related to each identified subject or keyword. In step 230 user type detector 140 may characterize each identified user as either real or fake as described in detail herein below. In step 240, attack identifier 150 may analyze the discourse, identify an attack, e.g. the prevalence of fake users and or fake content, and provide a user interface to display the status of the discourse. Attack identifier 150 may also create and send alerts via various means such as email and/or SMS or any other messaging mean in case of an attack.

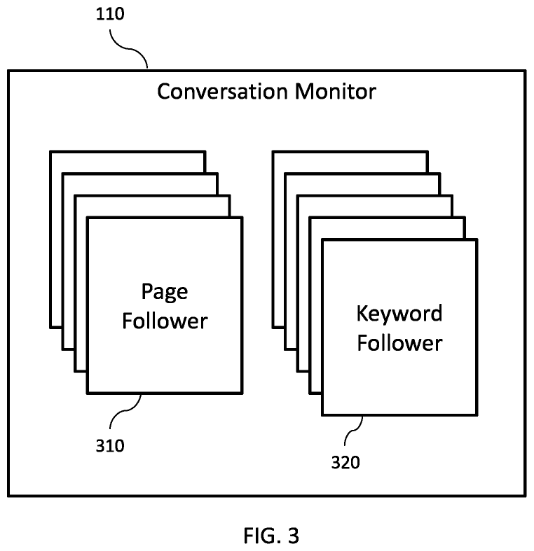

FIG. 3, to which reference is now made, is a schematic illustration of conversation monitor 110, constructed and operative in accordance with an embodiment of the invention. Attacks may include spreading disinformation (i.e. Fake News) related to the customer in his owned social media pages and/or in other pages which are of interest to the customer (such as a fan page). In addition, attacks may target the customer related trademarks and keywords in additional locations in the social media. Conversation monitor 110, connected to the social networks via the internet 101, comprises a page follower 310 per page and a keyword follower 320 per keyword. Page follower 310 and keyword follower 320 may pinpoint users active in the discourse and store information regarding the identified users in database 120. Page follower 310 may follow the discussions on the relevant pages such as customer owned pages and pages of interest and identify users who are active in the discussions. Keyword follower 320 may identify discussions where customer related keywords show up and identify the users using those keywords.

Each page follower 310 may continuously monitor a specific page that is of interest to the customer in an online social network and may retrieve from that page information such as friend requests, published content along with its publisher and may store the retrieved information in database 120.

Conversation monitor 110 may control the number of page followers 310 according the actual pages which are of interest to the customer. and may add and remove page followers 310 as necessary.

Each keyword follower 320 may continuously monitor the social networks and look for any appearance of a certain word or phrase and may retrieve the content containing that word or phrase along with its publisher and may store the information in database 120.

Conversation monitor 110 may determine the keywords according to manual configuration of words and/or statistical characteristics of common words used in the discourse. Conversation monitor 110 may control the number of keyword followers 320 and may add and remove keyword followers 320 as necessary.

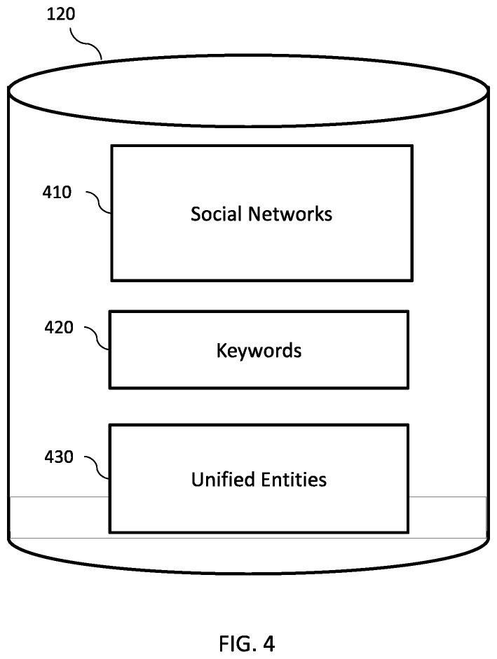

FIG. 4, to which reference is now made, is a schematic illustration of database 120 storing information used by attack detector system 100, operative in accordance with an embodiment of the invention. Database 120 comprises a social network section 410, a keyword section 420 and a unified entity section 430.

Conversation monitor 110 may store conversations gathered by the plurality of page followers 310 and the plurality of keyword follower 320 as well as the users participating in the conversations in social network section 410. Conversation monitor 110 may use the words stored in keyword section 420 for managing keyword followers 320 as words may be added and deleted during the operation of attack detector system 100. Unified entity section 430 may store processed consolidated information regarding each user identified by conversation monitor 110 according to his or her digital signature in the different social network as is described in more details herein below.

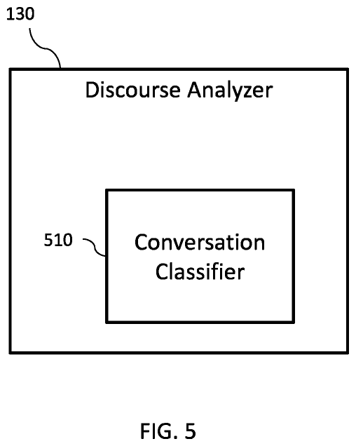

FIG. 5, to which reference is now made, is a schematic illustration of a discourse analyzer 130, constructed and operative in accordance with an embodiment of the invention. Discourse analyzer 130 may analyze the sentiment of the discussion and identify its nature. Discourse analyzer 130 may identify conversations related to the discourse and may identify the users participating in each conversation. Discourse analyzer 130 comprises a conversation classifier 510.

Conversation classifier 510 may classify the discourse and identify frequent subjects and keywords used during the conversations. Conversation classifier 510 may store the identified subjects and keywords in keyword section 420 of database 120 to be used by conversation monitor 110 when creating and activating keyword followers 320.

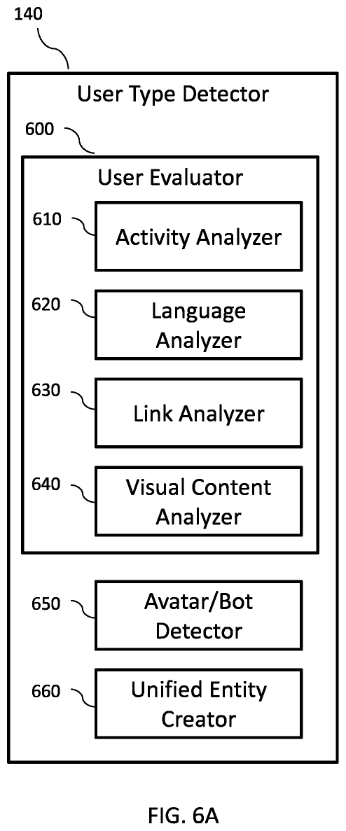

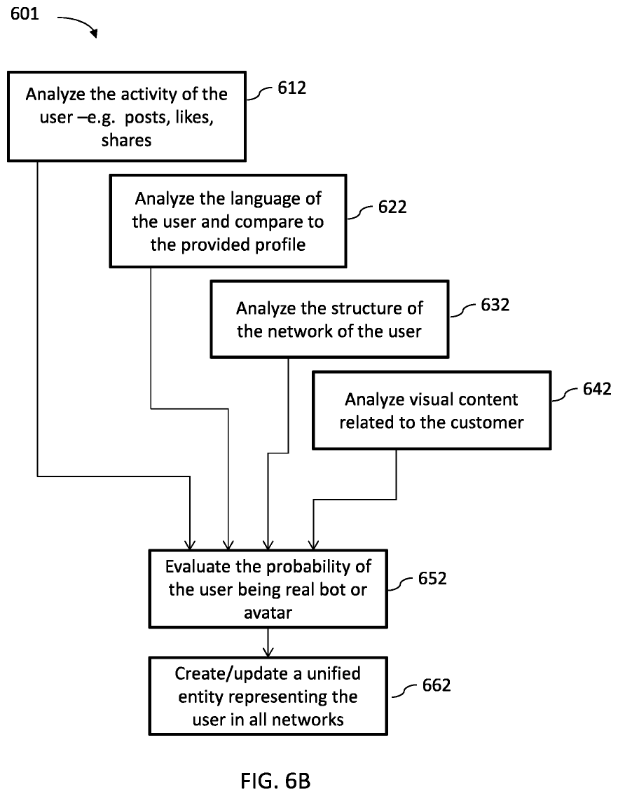

FIG. 6A, to which reference is now made, is a schematic illustration of a user type detector 140, constructed and operative in accordance with an embodiment of the invention.

User type detector 140 may identify the type of each user participating in the discourse as either a fake user or a real user and may create a unified entity representing the digital footprint of the user in the entire social media (in addition to the information extracted from each online social network and stored per social network). The type of the user may be determined by applying a set of tests, each test built from a set of parameters associated with the user (including the user's friends) and a set of rules associated with one or more parameters. Each test (i.e. combination of parameters and rules) may contribute some amount of certainty, indicated by a weight, to an overall calculated weighted average score (the total score) which represents the user's reliability.

The test may be implemented using machine learning tools such as artificial neural networks (ANN) where the rules may be the type and the structure of the neural network, and the score may be the output of the neural network. For example, the test may be to run the random forest supervised learning algorithm using a gradient boosting technique (XBoost) on an input comprised of parameters related to a specific user organized in a specific order.

User type detector 140 may apply any combination of tests and may determine the weight of each test in the calculation of a total score representing the probability of the user of being fake. User type detector 140 may modify the tests, set of parameters and rules in each test and may update the weight of each test. User type detector 140 may use machine learning techniques to identify new parameters, and new rules and to update the weight of the different tests of the overall type detection procedure. User type detector 140 may also use machine learning tools (such as a random forest algorithm) to evaluate the total score where the input parameters may be the output of the various tests.

User type detector 140 comprises a user evaluator 600 that may evaluate the characteristics of the user according to the different tests (parameters and rules) and provide indications regarding its authenticity; a fake user detector 650 that may evaluate the authenticity of a user based on the outcome of user evaluator 600 and possibly based on the unified entity of the user; and a unified entity creator 660 to create and update a unified entity, representing the user in the social media. In one embodiment of the invention user evaluator 600 comprises an activity analyzer 610; a language analyzer 620; a link analyzer 630 and a visual content analyzer 640. It may be noted that analyzers may be added and removed, their structure may change, and the relative weight of each analyzer may be modified.

Activity analyzer 610 may analyze the actions performed by each user and the actions performed by his friends in any online social network according to the predefined rules and provide a user activity score that reflects the probability of the user being a fake user according to his activity. Since the activity of a fake user in the social media is different than the activity of a real user, analyzing the social media activity of both the user and his friends may provide an indication regarding his authenticity.

Activity analyzer 610 may for example evaluate activities such as posts the user wrote, changes he made to his posts, pictures he posted, games he joined, location he tagged, groups he joints, events he reacted to etc. The evaluation may include counting the posts and comments he posted, the groups he joined, the pages he liked, the locations he announced, and other social media activities he performed. The evaluation may also include evaluating the response time for the user to respond to actions made by other users. Activity analyzer 610 may also evaluate actions related to the user, made by other users, actions such as responses to the user's posts, tags of the user in pictures, likes related to the user activity etc. An analysis that implies that user is almost or totally inactive in the social media, and has minimum interaction with other real users or an analysis that implies a user has no friends sharing his family name may also reduce the overall activity score and so on. The parameters and rules related to the activity may also relate for example to the profile creation procedure, or to actions related to the maintenance of the profile and other activities of the user in the social network.

Language analyzer 620 may provide an indication regarding the reliability of the actual data supplied by the user in his profile by comparing between the user's profile and the user's written expression. Language analyzer 620 may analyze the language used by the user (e.g. in posts) and extract a set of features characterizing the user and create an expected profile according to the actual language he uses in his posts. Language analyzer 620 may estimate from the analyzed text characteristics such as gender, age, nationality, education, work experience, etc., create an expected profile and compare the actual profile provided by the user in the social media with the rendered expected profile as obtained from the actual text. Language analyzer 620 may provide a language score according the comparison outcome reflecting the degree of variation between the actual and expected profiles. If large discrepancies exist between the user's actual profile and the user's expected profile the language score may be low. Language analyzer 620 may compare the expected profile with the unified entity of the user, if such already exists in database 120, and update the language score accordingly.

An example may be analyzing text of a user whose profile indicates that the user is an educated 35-year-old Christian, male, living in Arizona USA and receiving an expected profile of a simple immigrant old lady. The discrepancies between the expected profile and the actual profile may result in a low language score for that user.

In an embodiment of the invention language analyzer 620 may support several different languages and may provide an expected profile using a relatively small number of words in the text.

Link analyzer 630 may analyze the structure of the user network and may detect anomalies in the structure such as detecting sub-networks of bots, missing characterization and tagging of sub-networks, identification of sub-networks of un-related users and the like, and provide a network structure score according to the detected anomalies. In addition, link analyzer 630 may identify entire fictitious networks that user type detector 140 may also take into consideration during the type determination process.

Visual content analyzer 640 may analyze visual content (e.g. image, video) posted by the user and may identify whether the content is genuine, generated or modified. Genuine visual content may include for example an image taken by a camera. Generated visual content may include synthetic media, created by machine learning tools such as generative adversarial network (GAN). Modified content may include modifications made to genuine visual content using tools such as common image processing tools. Image analyzer 640 may provide an image authentication score corresponding to the origin of the visual content (genuine, generated or modified) and to the quantity and quality of modifications in case of modified content. Visual content analyzer 640 may identify generated visual content created by GAN (e.g. fabricated images) and/or Deepfake (e.g. re-enactment and face swap) using machine learning techniques (such as GAN). If image analyzer 640 detects a large amount of modifications or detect that the visual content is a synthetic media, the image authentication score may be low. Fake user detector 650 may use all the scores provided by the analyzers of user evaluator 600 and may determine whether a user is fake or real according to the different scores and their weight compared to configured thresholds, and, for a fake user, may provide an indication regarding the type of the fake user, i.e. an avatar or a bot in a network of fake users. Fake user detector 650 may also use the unified entity information stored in database 120 when determining the probability of a user being a fake user.

A unified entity creator 660 may create a single unified entity for each user containing the information collected from the social media and the outcome of the analysis performed by user evaluator 600. Unified entity creator 660 may compare and correlate activities in different social networks in order to merge details from accounts of the same user in different online networks into a single unified entity. For example, a user that published posts in one social network using one profile may be identical to a user that published the same posts in another social network using a second profile. Unified entity creator 660 may realize that the two profiles belong to the same user and add the relevant details from both networks to the unified entity. Unified entity creator 660 may calculate a unified weighted score that may provide the probability of a user being a fake user considering the score in each network and may update the details in database 120.

As mentioned herein above, the weighted score of each test may be an output provided by a machine learning tool, such as a neural network, and may indicate the probability of a user being fake based on features extracted from the user's activities in the different social networks and used as an input to the machine learning tool.

FIG. 6B, to which reference is now made, is a schematic illustration of a flow 601 implemented by user type detector 140 according to an embodiment of the invention. In step 612, activity analyzer 610 may analyze the activity of the user related to, for example, posts, likes, shares, images, groups, locations and etc., and may provide hints regarding the probability of a user being a real user or a fake one.

In step 622, language analyzer 620 may analyze the language used by the user in the social network and may compare the language with the profile provided by the user and may provide hints regarding the probability of a user being a real user or a fake one.

In step 632 link analyzer 630 may analyze the structure of the network of the user and may provide hints regarding the probability of a user being a real user or a fake one according to anomalies in the network structure.

In step 642 visual content analyzer 640 may analyze visual content (images, videos, etc.) related to the user and may provide hints regarding the probability of a user being a real user or a fake one based on the category of visual content he posted (i.e. generated, manipulated or genuine). It may be appreciated that user type detector 140 may activate steps 612, 622, 634 and 644 concurrently or in any order.

In step 652 fake user detector 650 may use the hints received from the different analyzers and may provide an assessment regarding the type of the user, whether he is a real or a fake user and in case of a fake user, fake user detector 650 may further estimate the type of the fake user—a bot or an avatar. In this assessment fake user detector 650 may use the information associated with the unified entity of the user. In step 662 unified entity creator 660 may update the unified entity of the user or create one if not already created.

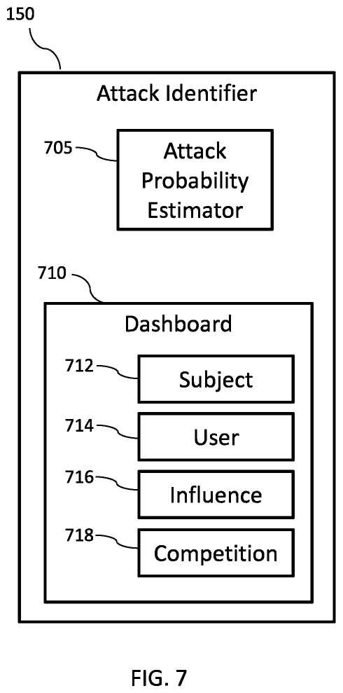

Attack detector 100 may discover insights regarding the “real” discourse concerning the customer's brand. The insights may include identified subjects and issues perceived as common thoughts but are actually part of a negative campaign operated by fake users or by a mix of fake and real users. The discourse may be an orchestrated campaign initiated by one or more real users and amplified by fake users. Attack detector 100 may identify fake users leading the negative campaigns and may provide insights regarding the degree of reliability of each fake user, the strength of its profile and his contribution to the discourse as expressed by his actions such as posts, likes and shares. Attack detector 100 may provide a variety of discourse segmentations according to parameters such as real and fake conversations, platforms, dates, subjects and the like. The insight and detailed information may be displayed to the customer via attack identifier 150 described herein with regards to FIG. 7.

FIG. 7, to which reference is now made, is a schematic illustration of attack identifier 150, constructed and operative in accordance with an embodiment of the invention. Attack identifier 150 may compute the probably that the discourse is actually an attack, or an orchestrated negative campaign, against the customer and may provide a user interface to the customer providing visual indications regarding the nature of the discourse. Attack identifier 150 may also provide a clear indication regarding attacks and negative campaigns and provide a friendly access for configuring thresholds for attacks related parameters such as number of harmful conversations, number of fake users active in a discourse, number of reaction (e.g. likes, shares) to a negative post, number of Deepfake posts and the like. Attack identifier 150 may also provide access to all its raw data in order for example to enable a human inspection of the data, perform additional deep analysis of the data, remove false liars, etc. Attack identifier 150 comprises an attack probability estimator 705 and a dashboard 710.

Attack probability estimator 705 may assess the probability of an attack according to the discovered sentiment of the discourse and the number of users identified as fake users participating in the discourse.

Dashboard 710 may display data and insights collected and/or discovered from the discourse. The user interface may provide a clear indication regarding negative campaigns in any of the online social networks and relevant details regarding such campaigns including identification of fake users.

Dashboard 710 may display the information related to the discourse using any type of user interface with any type of components and gadgets such as text, icons, graphs and the like to clearly visualize the information regarding the discourse. Dashboard 710 comprises a subject section 712, a user section 714, an influence section 716 and a competition section 718

Subject section 712 of dashboard 710 may display the main subjects and keywords used in the discourse and display a graph presenting the sentiment of the discourse over time in addition to the type of publications to which the public was exposed during the discourse. Subject section 710 may also provide a quantified insight regarding the impact of each campaign, the number and type of users participating in different conversations of the discourse and how many users were exposed to each conversation.

User section 714 may display the fake users participated in the discourse including details regarding each fake user and.

Influence section 730 may provide an indication regarding the size of the audience exposed to the fake campaign, what was the effect of the campaign and what was its viral extent.

Competition section 740 may provide a competitor analysis that includes details regarding the discourse related to the customers' competitors, the extent of exposure to competitors discourse and exposure of competitors to attacks.

Attack identifier 150 may also provide a user interface that enables access to the raw data collected by the system, including the conversations, users and intermediate result computed by attack detector 100.

A system constructed and operative in accordance with the invention continuously monitors the social media and provides quick identification of attacks (negative campaigns) and clear indications regarding attacks on a brand or an individual in social networks. Once an attack is identified, the system provides information regarding the attackers, the extent and impact of the attack and insights regarding competitors' activity in the social media.

It may be appreciated by the person skilled in the art that the different parts of the system, shown in the different figures and described herein, are not intended to be limiting and that the system may be implemented by more or less parts, or with a different arrangement of parts, or with one or more processors performing the activities of the entire system, or any combination thereof. It may also be appreciated by the person skilled in the art that the steps shown in the different flows described herein are not intended to be limiting and that the flows may be practiced with more or less steps, or with a different sequence of steps, or any combination thereof.

Unless specifically stated otherwise, as apparent from the preceding discussions, it is appreciated that, throughout the specification, discussions utilizing terms such as “analyzing”, “processing,” “computing,” “calculating,” “determining,” “detecting”, “identifying” or the like, refer to the action and/or processes of a general purpose computer or computing device or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may include apparatus for performing the operations herein. This apparatus may be specially constructed for the desired purposes, or it may comprise a general-purpose computer selectively activated or reconfigured by a computer program stored in the computer. The resultant apparatus when instructed by software may turn the general-purpose computer into inventive elements as discussed herein. The instructions may define the inventive device in operation with the computer platform for which it is desired. Such a computer program may be stored in a computer readable storage medium, suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description. In addition, embodiments of the invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for identifying attacks against a customer in a social network, the system comprising:
a conversation monitor to discover a plurality of users participating in a discourse related to the customer;
a user type detector to identify a type of a user, from the plurality of users, as either real or fake; and
an attack identifier to identify an attack according to the type of the users.

2. The system of claim 1 wherein an attack is a negative campaign that comprises one or more fake users and is orchestrated by one or more real users.

3. The system of claim 1 also comprising a discourse analyzer to identify one or more key elements in the discourse, the conversation monitor to discover the plurality of users participating in conversations containing one of the key elements.

4. The system of claim 1 wherein the user type detector also comprises an activity analyzer to analyze an activity of each user and to provide indications regarding the type of the user according to the activity.

5. The system of claim 1 wherein the user type detector also comprises a language analyzer to analyze a language of each user and provide indications regarding the type of the user according to the language.

6. The system of claim 1 wherein the user type detector also comprises a link analyzer to analyze a structure of a social network of each user and provide indications regarding the type of the user according to the structure of the social network.

7. The system of claim 1 wherein the user type detector also comprises a visual content analyzer to analyze a category of visual content, related to each user, the category of content is one of: genuine, modified and generated and provide indications regarding the type of the user according to the detected type.

8. The system of claim 7 wherein the visual content analyzer to use a generative adversarial network (GAN) to detect generated visual content.

9. The system of claim 1 wherein the user type detector also comprises a fake user detector to define whether a fake user is a bot or an avatar in a network of fake users.

10. The system of claim 1 wherein the user type detector also comprises a unified entity creator to create for each user a unified entity representing the user in a plurality of networks.

11. The system of claim 1 wherein the attack identifier to identify an attack according to the number of users having a type fake.

12. A method for identifying attacks against a customer in a social network, the method comprising:
discovering users participating in a discourse related to the customer;
identifying a type of each user; and
identifying an attack according to the type of the users.

13. The method of claim 12 wherein an attack is a negative campaign that comprises one or more fake users and is orchestrated by one or more real users.

14. The method of claim 12 also comprising identifying one or more key elements in the discourse and discovering the plurality of users participating in conversations containing one of the key elements.

15. The method of claim 12 wherein the identifying also comprises analyzing an activity of each user and providing indications regarding the type of the user according to the activity.

16. The method of claim 12 wherein the identifying also comprises analyzing a language of each user and providing indications regarding the type of the user according to the language.

17. The method of claim 12 wherein the identifying also comprises analyzing a structure of a network of each user and providing indications regarding the type of the user according to the structure of the network.

18. The method of claim 12 wherein the identifying also comprises:
detecting a category of visual content related to each user, the category is one of: genuine, modified and generated; and
providing an indication regarding the type of the user according to the detected type.

19. The method of claim 12 wherein the identifying also comprises defining whether a fake user is either a bot or an avatar.

20. The method of claim 12 wherein the identifying also comprises creating for each user a unified entity representing the user in a plurality of networks.

21. The method of claim 20 wherein the identifying also comprising considering characteristics of the unified entity.

22. A method for identifying a fake user in a social network, the method comprising:
evaluating an authenticity of a user by applying a set of tests, each test in the set comprising one or more rules on one or more parameters associated with the user, each test creating a weighted score;
calculating a weighted average score from the weighted scores; and
determining if a user is fake according to the weighted average score compared to a configured threshold.

23. The method of claim 22 wherein a test is an artificial neural network (ANN), the rules are the structure of the ANN and the weighted score is the output of the ANN.

24. The method of claim 22 wherein the set of tests comprises:
analyzing the language of the user and extracting a set of characteristics;
building an expected profile from the characteristics;
comparing the expected profile with an actual profile provided by the user; and
creating a language score reflecting the degree of variation between the expected profile and the actual profile.

25. The method of claim 22 wherein the set of tests comprises:
detecting a category of visual content related to each user, the category is one of: genuine, modified and generated; and
providing an indication regarding the type of the user according to the detected category.

26. The method of claim 22 wherein the detecting a category of visual content comprises using a generative adversarial network (GAN) to detect generated visual content.
